(19) United States
(12) Patent Application Publication
(10) Pub. No.: US 2017/0138752 A1
(43) Pub. Date: May 18, 2017

(54) Method and System for Providing Personalized Navigation Services and Crowd-Sourced Location-Based Data

(71) Applicant: Yakov Z. Mermelstein, Spring Valley, NY (US)

(72) Inventor: Yakov Z. Mermelstein, Spring Valley, NY (US)

(21) Appl. No.: 15/187,400

(22) Filed: Jun. 20, 2016

Related U.S. Application Data
(60) Provisional application No. 62/182,218, filed on Jun. 19, 2015.

(51) Int. Cl. G01C 21/34; G08G 1/0967; G01C 21/30; G01S 19/45; G08G 1/16; G08G 1/01; G08G 1/04; H04W 4/02; G01C 21/36

(52) U.S. Cl. CPC G01C 21/3484; H04W 4/023; G08G 1/09675; G01C 21/30; G01C 21/3492; G01C 21/3602; G08G 1/161; G08G 1/012; G08G 1/04; G08G 1/166; G01S 19/45

(57) ABSTRACT

A system for updating location-based data available to a network of user includes a network of users connected to a server; a database comprising location-based information on the server accessible to the network of users, the location-based information including global positioning system (GPS) coordinates of environmental conditions including traffic conditions, topographical information, weather information, road surface condition information, roadside object information, on-road object information, and combinations thereof; a vehicle including an image gathering device, the image gathering device in communication with the server; an image recognition module including software executing on a computer readable medium for performing image processing on images gathered from the image gathering device; software executing on a computer readable medium for updating the location-based information in the database based on processed images taken by the image gathering device; and an electronic map reflecting the location-based information in the database.

### CROSS-REFERENCE TO RELATED PATENT APPLICATION

This patent application claims a benefit to the filing date of U.S. Provisional Patent Application Ser. No. 62/182,218 that is titled “Method and System for Providing Personalized Navigation Services and Crowd-sourced Location-Based Data,” that was filed on Jun. 19, 2015. The disclosure of U.S. 62/182,218 is incorporated by reference herein in its entirety.

### BACKGROUND

Traditional maps have been rendered essentially obsolete in view of the proliferation of stand-alone navigation systems and navigation applications operating on personal electronic mobile devices. Modern navigation tools rely on the gathering of incredible amounts of data regarding the absolute and relative locations of objects of interest and their absolute and relative locations on an electronic map, data which is accessible to a user either through a local memory or through access to a remote database via the Internet.

Location-based data collection and maintenance has largely been the responsibility of the entities that supply the navigation services to an end user. However, the above-mentioned proliferation of personal electronic mobile devices has had the benefit of turning each user into a potential data collection source. Thus crowd-sourcing of information related to the location-based data, such as that described in U.S. Pat. No. 8,718,910 of Pelmorex Canada Inc., incorporated by reference herein in its entirety, is becoming a realistic solution to the problems facing modern navigation service providers.

Modern consumers constantly demand more content in a more streamlined package at a lower price. Those consumers are unlikely to continue using a service that operates in a clearly suboptimal manner or fails to reliably function as intended, even if on aggregate that service is advantageous to the user. This consumer attitude is of particular concern for navigation service providers. Road conditions can change in an instant due to a variety of factors completely out of the providers' control, such as traveler volume, traffic accidents, weather, road maintenance, the presence of police or emergency vehicles, and the like. The best navigational product will be the one that provides the fastest and most accurate updates to consumers about these factors.

Crowd-sourcing as discussed above is one such way that changes in certain location-based data can be identified and processed in substantially real-time. One navigation service that employs this crowd-sourcing technique is Waze® (Google Inc., Mountain View, Calif.). However, Waze® still requires manual input and interaction from its network of users in order to operate as intended. Beyond the obvious safety concerns associated with operating a personal electronic mobile device while operating a moving vehicle at speed, local governments are passing legislation making it illegal to operate personal electronic mobile devices while operating a motor vehicle.

Modern consumers also desire customized products and services. Whether designed from the beginning as a niche product appealing to a certain subset of the population or a more general product that allows a user to set preferences that drastically affect the look and function of a certain product or service, consumers have come to expect the option to “make it your own”. However, navigation products and services have hitherto provided the same content to everyone; presented with the same navigation platform as everyone else, a user must manually manipulate a proposed route to customize the route according to user preferences.

There is, therefore, a need for a system allowing crowd-sourced collection of location-based data that can be used to update and maintain location-based data supplied to a navigation service that does not require direct input from the network of users to gather the updated data. There is also a need to provide customized navigational services that allow a user's preferences to affect the route provided by the service.

Certain components of the generic structures for building the systems and performing the methods described in the present disclosure are described at least in part in PCT/EP2007/061682 of Sony Ericsson Mobile Communications AB, Japanese Patent Application No. 09188728 of Satoshi et al., and U.S. Pat. No. 7,928,905 of Mitac International Corp., the contents of which are incorporated by reference herein in their entireties.

### BRIEF DESCRIPTION OF THE DRAWINGS

The drawings show embodiments of the present disclosure for the purpose of illustrating the invention. However, it should be understood that the present application is not limited to the precise arrangements and instrumentalities shown in the drawings, wherein:

FIG. 1 portrays a system for providing personalized navigation servicing utilizing crowd-sourced consistent with some embodiments of the present disclosure;

FIG. 2 portrays a method of using the system shown in FIG. 1 consistent with some embodiments of the present disclosure; and

FIG. 3 pictographically portrays the system of FIG. 1 in use consistent with some embodiments of the present disclosure.

### DESCRIPTION

In one embodiment, the present disclosure is directed to a system for updating and re-presenting location-based data available to a network of users. In some embodiments, the system includes a network of users that collect location-based data and then subsequently access the location-based data. In some embodiments, the network of users includes at least one user having a vehicle.

In some embodiments, the vehicle includes at least one image gathering device installed on the vehicle. The at least one image gathering device monitors the environment surrounding the vehicle for environmental conditions. In some embodiments, environmental conditions include traffic conditions, topographical information, weather information, road surface condition information, roadside object information, on-road object information, and combinations thereof. As used herein, the terms “environmental condition” and “object of interest” are used interchangeably.

In some embodiments, an image recognition module identifies environmental conditions observed by the image gathering device. In some embodiments, the image recognition module incorporates image analysis software to identify objects in images forwarded to it by at least one image gathering device. In some embodiments, the image recognition module also identifies the location of the identified environmental condition. In some embodiments, the location of an environmental condition is determined exclusively through the use of image gathering devices. In some embodiments, the location of an environmental condition is determined through the combined use of image gathering devices and location devices. Suitable location devices include, but are not limited to, a global positioning system (GPS), RF tags, and the like. The location of a certain environmental condition can also be determined based on the known locations of known environmental conditions surrounding the certain environmental condition. For example, a pothole on a highway may be identified and then “located” either by the system recognizing the GPS location of the vehicle during the moments when the vehicle passes the pothole, or may identify the mile-markers on the side of the highway as well as the pothole's relative distance to those mile-markers to determine where the pothole is located on the highway. In some embodiments, substantially every road-going vehicle includes at least one image gathering device, an image recognition module, and a connection to the system for uploading location-based information.

In some embodiments, the at least one image gathering device is selected from the group consisting of a visible light camera, an ultraviolet (UV) light camera, infrared light camera, laser, and the like. The image gathering device captures images of the environment surrounding the vehicle for analysis by other components of the system. In some embodiments, the at least one image gathering device employs radar or sonar technology in conjunction with software executing on a computer readable medium for interpreting the radar and/or sonar signals as images or maps of the environment surrounding the vehicle. In some embodiments, the at least one image gathering device is a plurality of image gathering devices. In some embodiments, the image gathering devices are mounted to the vehicle to provide at least front view, at least rear view, and/or at least side view monitoring of the vehicle. In some embodiments, the image gathering devices are sufficient to monitor at least 45, at least 90, at least 180, at least 270, or 360 degrees around the vehicle.

In some embodiments, the vehicle includes at least one instrument for sensing motion of the vehicle. In some embodiments, the at least one instrument is an accelerometer or a gyroscope. In some embodiments, the accelerometer/gyroscope aids in the identification and location of potholes and other road condition related environmental conditions. The impact of the vehicle with the pothole is read through the accelerometer/gyroscope and uploaded to the database for incorporation into the electronic map. In some embodiments, the vehicle includes at least one instrument for measuring changes in altitude. Such an altimeter interfaces with the image gathering device and image recognition module to aid in determining the topography of the environment surrounding the vehicle and the incline severity of any roads.

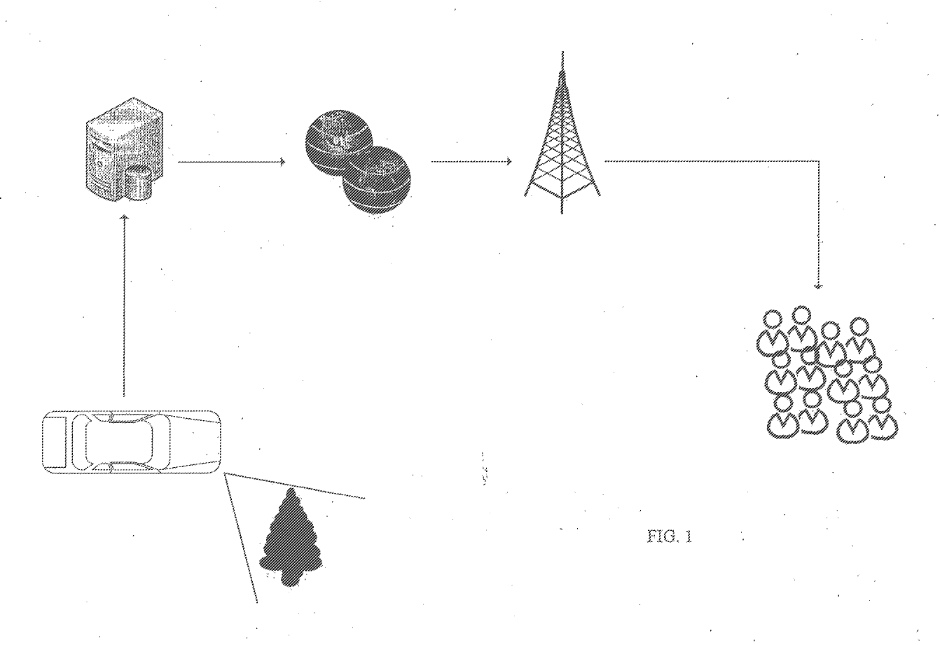

In some embodiments, the system further comprises a database including location-based data about environmental conditions, an electronic map reflecting the location-based data stored in the database, and the software and hardware (such as a server, CPU, and the like) necessary to receive updates to the location-based data in the database, implement these changes on the electronic map, and distribute the map to the network of users. In some embodiments, the image gathering device relays gathered images to the image recognition module. As shown in FIG. 1, upon identification of an environmental condition, the image recognition module assigns a location to the environmental condition and uploads the identification and identity of the environmental condition to the database, thus alerting the system of the presence of the environmental condition. The system then updates the electronic map to reflect the updated location-based data in the database so that any user within the network of users receives up to date information about the presence of an environmental condition at that location. In some embodiments, the image recognition module utilizes methods and algorithms for processing images and recognizing environmental conditions portrayed in those images, such as those described in US 2014/0334679 of Sony Corporation, incorporated herein by reference in its entirety.

In some embodiments, the location-based data is at least in part crowd-sourced. As used herein, the term “crowd-sourced” is used to refer to data that is gathered by users within the network of users and made available in some form to the other users of the network. In some embodiments, the crowd-sourced location-based data is re-presented to at least one of the users of the network to provide routing information for travel by car/motorcycle, by public transportation, by bicycle, or on foot. The continuous addition of location-based data by each of the network of users as well as by the provider of the service, coupled with the availability of that location-based information to the users of the system, means that the amount of data presented is always increasing and the quality of the services provided to the network of users based on the location-based data constantly improves. The system is able to detect patterns within the data, both on a global level and on an individual level. Patterns on a global level can include the relative road surface conditions on a state by state basis, the severity of elevation changes for roads is a certain area, the average amount of traffic on a certain road, and the like. Patterns on an individual level can result in the determination of user preferences. For example, patterns on an individual level can include a user's preference to avoid stop signs, traffic lights, major highways, side roads, steep and/or poorly maintained roads, and the like.

In some embodiments, location-based data is used to populate an electronic map for use by the network of users for navigation. The presence of environmental conditions at certain locations as determined by the network of users and uploaded to the database is reflected by the electronic map presented to the network of users by the system. In some embodiments, the electronic map is updated in real-time. In some embodiments, the map is updated at predetermined times intervals, such as every 30 seconds, every minute, 10 minutes, 30 minutes, hour, or greater. In some embodiments, the map is accessible via a user's personal electronic mobile device, such as a smart phone or tablet. In some embodiments, the electronic map is accessible through a navigation system installed in a vehicle. In some embodiments, a software application operating on an electronic device provides a user with navigation services using the electronic map and location-based data. In some embodiments, the software application accesses map data that is stored locally. In some embodiments, the software application accesses map data that is stored remotely in the database via a wired or wireless connection. In some embodiments, location-based data obtained by a user is uploaded to both the database of the system for distribution to all users in the network of users and also distributed to users within the network of users spatially located close to the user. Thus information directly relevant to the users in a certain area is quickly delivered to users in that area and also delivered to the system for distribution to all users in the event they travel through that location at a later date. In some embodiments, local sharing of location-based information is facilitated by the use of Bluetooth® (Bluetooth SIG, Inc., Kirkland, Wash.), Wi-Fi, or any other suitable vehicle-to-vehicle communication protocol or system.

By way of example, a construction crew begins maintenance on the outside lane of a highway by placing traffic cones on the outside lane starting a quarter of a mile before the construction zone which gradually require drivers traveling in the outside lane to merge to an inside lane. A first vehicle operated by a user from the network of users and including a suitable at least one image gathering device and image recognition module identifies the presence of these traffic cones and the closure of the outside lane of the highway. The presence of these cones and the construction zone is captured by the image gathering device as the vehicle encounters and passes those environmental conditions, and the identity and locations of these environmental conditions are determined through any suitable tool (e.g. GPS) by the image recognition module. The identity and location of these environmental conditions is then uploaded to the database and incorporated into the map data for that location by the system. When a second vehicle subsequently approaches the traffic cones, the presence of the construction zone has already been identified and incorporated into the electronic map provided to the user of the second vehicle. Thus, the second vehicle has prior warning of the changing road conditions. When the road maintenance is subsequently completed and the outside lane has been reopened to travelers, a subsequent vehicle carrying a user from the network of users and including a suitable at least one image gathering device and image recognition module identifies the absence of traffic cones and a construction zone where the electronic map continues to identify the presence of one. The image recognition module captures the free lane environmental condition, and the identity and location of this environmental condition are determined through any suitable tool (e.g. GPS) by the image recognition module. The location of this change in environmental condition is then uploaded to the database and incorporated into the map data for that location by the system. Another subsequent vehicle approaching that location will be presented with updated map data no longer including the construction zone.

In some embodiments, environmental conditions monitored by the at least one image gathering device include road signs. Thus the system will be updated to include traffic flow instructions which can be returned to a user within the network of users. In this embodiment, the system can alert the user to instructions printed on road signs that the user may have missed. For example, the system could identify a speed limit sign setting the speed limit for that road at 55 mph. Noting that the vehicle is currently traveling at 65 mph, the system alerts the user to adjust the speed of the vehicle accordingly. When parking, the system may alert a user to the presence of a “No Parking” sign or that a certain space is a “Handicap Only” zone, and alert the user that another space should be found in order to avoid a citation. In some embodiments, the image gathering device identifies the presence of two objects and can identify the distance between them using the relative sizes of known objects surrounding the two objects and/or the time necessary to travel between the two objects at a known speed. In some embodiments, the image gathering device determines the available space surrounding an object.

In some embodiments, the system of the present disclosure provides personalized routing information based on at least one of the environmental conditions uploaded to the database or observed global or individual patterns recognized by the system. In some embodiments, the personalized routing information reflects the crowd-sourced location-based data discussed in the present disclosure. In some embodiments, the personalized routing information reflects conventional location-based data collections. Personalized routing information takes into account user preferences. In some embodiments, user route preferences are set manually. For example, a user who dislikes back roads and stoplights may manually select a preference to limit interaction with these environmental conditions in routes provided to them. In general, therefore, the system will route this user to his or her destinations using highways and will attempt to traverse cities in ways that avoid stoplights. In some embodiments, user route preferences are set automatically. For example, a user that decides to take a bike trip can be directed onto a route with greater or lesser topographical changes based on the route difficulties customarily used in the past by that user and observed by the system when going on bike trips. In another example, a user taking a walk can be directed by the system in certain directions to avoid busy intersections, roads without sidewalks, unlit streets, and other factors based on how the system has recognized a user usually to walk from place to place. User preferences for a route that can be manually or automatically set include, but are not limited to, time of day, time of arrival at a destination, presence/absence of stop signs, presence/absence of stop lights, number of hills, severity of hills, road conditions, use of highways, use of back roads, speed limits, travel duration, and the like.

In some embodiments, the crowd-sourced location-based data is provided to a user as a series of directions to guide a user from one place to another. The route ultimately offered to a user can be determined by breaking the route down into shorter routes between “nodes” and then finding the path between these nodes to the destination that has the most desirable “weight”. In some embodiments, environmental conditions are assigned various weights according to user preferences and the presence of a certain environmental condition contributes to the weight of the route upon which it is located. In some embodiments, the total weight of a route is the total sum weight of all environmental conditions along the route and the weight added by the total distance of that route. A desired weight may be the highest aggregate weight to the destination or the lowest aggregate weight to the destination, depending on how the path between each node is weighted. For example, where the lowest weight is considered the “most desirable”, the same highway will be assigned a low weight for users who prefer to use highways and a higher weight for those that usually wish to avoid highways. Alternatively, where the highest weight is considered the “most desirable”, the same highway will be assigned a higher weight for users who prefer to use highways and a lower weight for those that usually wish to avoid highways. In some environments, the same analysis is performed for all environmental conditions. Thus environmental conditions such as hills, stop lights, stop signs, potholes, traffic, police and/or emergency vehicles, and the like are incorporated into the weight of the route based on user preference, and the route with the most desirable weight is the one returned to the user. In some embodiments, public transportation is incorporated into the weight calculations for the returned route. In some embodiments where the weight of a route incorporating public transportation is found to be the most desirable, the system will direct the user to incorporate public transportation as part of the route. In some embodiments where the weight of another mode of public transportation has a more desirable weight than that of the current mode of public transportation (for instance staying on a certain bus is less desirable than getting off that bus, boarding another bus to take the user to a train which then takes the user closer to a destination where they can then take another bus), those instructions are provided to the user. In some embodiments, the system recognizes that while a certain route has the most desirable weight, taking the same route at a later time results in even more desirable weight. For example, the system identifies a certain bus line as the best way for a user to get uptown, but the 2:30PM bus has more stops and travels a greater distance, while the 3:00PM bus has fewer stops and will result in the user spending less time on the bus. In some embodiments, the system will instruct the user to take the later bus even if that bus will arrive at the destination later than the first bus. In some embodiments, the system also takes into account routes requiring bicycles and walking when calculating weight.

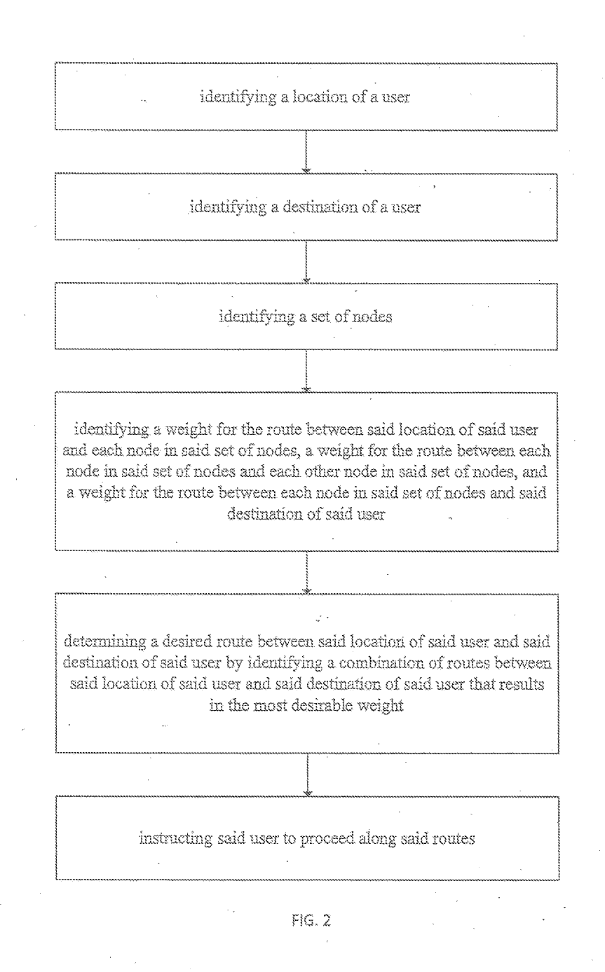

As shown in FIG. 2, in some embodiments, the present disclosure is directed to a method of providing personalized navigation services including the steps of identifying a location of a user, identifying a destination of a user, identifying a set of nodes, identifying a weight for the route between the location of the user and each node in the set of nodes, a weight for the route between each node in the set of nodes and each other node in the set of nodes, and a weight for the route between each node in the set of nodes and the destination of the user, determining a desired route between the location of the user and the destination of the user by identifying a combination of routes between the location of the user and the destination of the user that results in the most desirable weight, and instructing the user to proceed along the routes. In some embodiments, the weight for each route is determined by environmental conditions within each route and the user's preference for the environmental conditions. In some embodiments, preferable environmental conditions have a lower weight than non-preferable environmental conditions and the most desirable weight is the lowest possible weight. In some embodiments, preferable environmental conditions have a higher weight than non-preferable environmental conditions and the most desirable weight is the highest possible weight. In some embodiments, the user's preference for the environmental conditions is set manually. In some embodiments, the user's preference for the environmental conditions is set automatically and/or based on the user's previous navigation behavior. In some embodiments, the user's navigation behavior, and by extension a user's preferences and the personalized weight assigned to certain environmental conditions, is determined through the at least one image gathering device and image recognition module discussed elsewhere in the present disclosure.

In some embodiments, the at least one environmental condition detected by the image gathering device is another vehicle or object in the road. By identifying the vehicles surrounding it, a user's vehicle can determine environmental conditions such as the speed of oncoming or same direction traffic (recognizing the rate at which the image of a vehicle changes and comparing it to the speed of the user's vehicle), traffic patterns, broken down vehicles, the presence of emergency vehicles and police, and the like. Each of these recognized environmental conditions can be uploaded to the database and used to update the electronic maps accessible to other users of the system. As discussed above, in some embodiments, a recognized environmental condition is provided as an alert to the user. In some embodiments, the system interfaces with systems that control the movement of the vehicle itself. In some embodiments, the system instructs the vehicle to adjust its speed. In some embodiments, the system instructs the vehicle to adjust the direction in which it is traveling.

By way of example, an image gathering device installed in the front of the vehicle identifies the presence of another vehicle ahead and calculates based on the relative speed of user's vehicle and the other vehicle that a collision is likely. In this example, the system instructs the user to apply the brakes. In some embodiments, the system instructs the vehicle to apply the brakes itself. By way of further example, an image gathering device installed on the rear of the vehicle identifies the presence of another vehicle behind the user's vehicle and recognizes that the other vehicle is not slowing down sufficiently to prevent collision with the user's vehicle. In this example, the system instructs the user to apply more throttle. In some embodiments, the system instructs the vehicle to apply more throttle itself. In some embodiments, the image gathering device might recognize ample space for the user's vehicle to move in order to avoid a collision. In this example, the system instructs the user to change the direction of the vehicle to occupy that space (e.g. change lanes). In some embodiments, the system instructs the vehicle to change direction on its own, temporarily wresting control of the vehicle from the user until the collision threat is averted. In some embodiments, an image gathering device is installed on the side of the car.

In some embodiments, the at least one image gathering device and image recognition module identify an environmental condition, such as another vehicle or other object such as an animal, which is on a trajectory to cross paths with the trajectory of the user's vehicle. In some embodiments, the system alerts the user of the vehicle of the environmental condition. In some embodiments, the system recognizes that the user and the environmental condition are on course to collide, and applies the throttle, brakes, or adjusts the steering wheel accordingly to avoid or limit the severity of the collision.

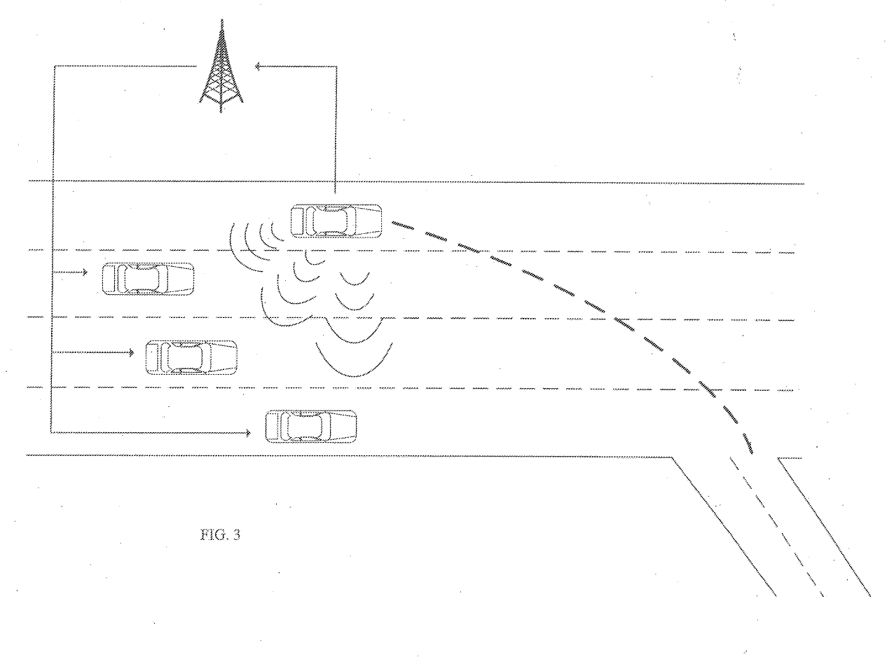

In some embodiments, the system recognizes likely direction or speed changes of surrounding vehicles and alerts a user's vehicle. For example, the system is instructing a vehicle to proceed to its destination by exiting a highway from the right hand lane. However, the system is also recognizing that the vehicle is currently operating in the left hand lane and will need to perform several lane changes in order to make that exit. The system alerts other vehicles in the vicinity that this vehicle is likely to change several lanes quickly in order to make its exit. This embodiment may be implemented in lieu of or in addition to the above-identified embodiments wherein the system may temporarily take control of a vehicle to avoid a collision. As shown in FIG. 3, in some embodiments, surrounding vehicles are alerted of the likely direction or speed changes of a nearby vehicle identified by the system via local communication as described above. In some embodiments, surrounding vehicles are alerted by an upload from the system database itself.

In some embodiments, the at least one image gathering device and image recognition module identify an environmental condition being an available parking space. An at least one image gathering device and image recognition module identify free space between two objects, such as between two cars on the side of the road, between two cars in a parking lot, between one car and another object, and the like. If the free space is determined large enough to accept a parked car, then the free space is identified as an “available parking space” environmental condition. The presence of this environmental condition is then uploaded to the system and stored in the database so as to be viewable by all users within the network of users.

In some embodiments, the environmental condition identified by the at least one image gathering device and the image recognition module is the weather in the environment surrounding the user's vehicle. Weather effects can be recognized, uploaded to the system database, and incorporated into the electronic maps available to the network of users in various ways. In some embodiments, the mere presence of certain weather conditions is recognized and incorporated. In this embodiment, the environmental condition would be, for example, the presence of rain, snow, ice, fog, and the like. In some embodiments, weather is indirectly reported to the system by recognizing weather effects. For example, the image recognition module recognizes standing water on the road and reports slippery or hazardous road conditions to the system. In some embodiments, limited visibility observed by the at least one image gathering device is identified as an environmental condition and reported to the system.

In some embodiments, the system further implements a heads-up display (HUD) within the user's vehicle. In some embodiments, the HUD is projected onto a conventional or lightly modified conventional windscreen so as to appear to “float” in the environment surrounding the user's vehicle. In some embodiments, the HUD is integrated into the vehicle by replacing the windshield with a transparent display. Location-based information from the database may be visualized within the HUD so as to call a user's attention to environmental conditions. In some embodiments, road surface condition alerts such as potholes may be highlighted on the HUD so that users can navigate around them. In some embodiments, like that described above with respect to alerts regarding surrounding vehicles, a vehicle likely to quickly change speed or direction is identified to a user through the HUD. Roadside objects can be identified, for instance with a user's destination highlighted in the distance and moving within the HUD accordingly as the user's vehicle approaches. In some embodiments, the system includes eye tracking so that the user's eye level and direction of vision can be taken into account when displaying information on the HUD.

In some embodiments, the present disclosure is directed to a method of using an image recognition system integrated into a vehicle including the steps of providing at least one image gathering device, providing an image recognition module, providing a database storing environmental conditions reported by the image gathering device and the image recognition module, a network of users, the users having vehicles, installing the at least one image gathering device on at least one of the vehicles, gathering image data of a surrounding environment of the vehicle using the image gathering device, identifying at least one environmental condition in the surrounding environment, determining the location of the at least one environmental condition, reporting the environmental condition to the database, incorporating the reported environmental conditions into an electronic map available to the network of users, sending the electronic map to at least one user of the network of users.

In some embodiments, the method determines if an object in front or back of the vehicle is standing still, moving towards the vehicle, moving away from the vehicle, and if moving, at what speed. In some embodiments, the method determines if an object is likely to cross the trajectory of the vehicle, at what angle, and at what speed. In some embodiments, the method determines the availability of space surrounding the vehicle. In some embodiments, the method determines the availability of space surrounding an object. In some embodiments, the method determines the amount of space between at least two objects. In some embodiments, the method identifies environmental conditions that are objects identifying whether a road is open or closed. In some embodiments, the method identifies environmental conditions that are road signs. In some embodiments, the method identifies environmental conditions that are weather effects, including the presence of moisture, slippery conditions, decreased visibility, and the like. In some embodiments, the method identifies environmental conditions that are other vehicles, including other user's vehicles, emergency vehicles, police, and the like.

In some embodiments, the image recognition module controls the user's vehicle in response to the presence of at least one certain environmental condition. In some embodiments, the control from the image recognition module accelerates, decelerates, or steers the vehicle. In some embodiments, the control from the image recognition module is used to avoid a collision with the at least one certain environmental condition. In some embodiments, other vehicles in the surrounding environment are alerted of likely speed or direction changes from the user's vehicle. In some embodiments, the image recognition module controls the user's vehicle to avoid potential collisions with other vehicles likely to suddenly change speed or direction.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for updating location-based data available to a network of users, said system comprising:
a network of users connected to a server;
a database comprising location-based information on said server accessible to said network of users, said location-based information including GPS coordinates of environmental conditions including traffic conditions, topographical information, weather information, road surface condition information, roadside object information, on-road object information, and combinations thereof;
a vehicle including an image gathering device, said image gathering device in communication with said server;
an image recognition module including software executing on a computer readable medium for performing image processing on images gathered from said image gathering device;
software executing on a computer readable medium for updating said location-based information in said database based on processed images taken by said image gathering device; and
an electronic map reflecting the location-based information in said database.

2. The system according to claim 1 wherein said image gathering device is a visible light camera, a UV light camera, an IR spectrum camera, a laser system, a radar system, and combinations thereof.

3. A method of updating location-based data available to a network of users, said method comprising the steps of:
detecting via an image gathering device installed on a vehicle at least a first object of interest;
detecting a proximity of said at least a first object of interest to said vehicle;
detecting movement of said at least a first object of interest relative to said vehicle;
detecting if said at least a first object is crossing a trajectory of said vehicle and at what speed; and
determining if any space surrounding said vehicle is available.

4. The method of updating location-based data available to a network of users according to claim 3, further comprising the steps of:
detecting via said image gathering device installed on the vehicle at least a second object of interest; and
determining a distance between said at least a first objection of interest and said at least a second object of interest.

5. The method of updating location-based data available to a network of users according to claim 4, wherein said at least a first object is a first parked car and said at least a second object of interest is a second parked car.

6. The method of updating location-based data available to a network of users according to claim 3, wherein said at least a first object is a weather condition.

7. The method of updating location-based data available to a network of users according to claim 6, wherein said weather condition is visibility.

8. The method of updating location-based data available to a network of users according to claim 3, wherein said at least a first object is an indicator that the road is closed.

9. The method of updating location-based data available to a network of users according to claim 3, wherein said at least a first object is an indicator that the road is open.

10. The method of updating location-based data available to a network of users according to claim 3, wherein said at least a first object is an emergency vehicle.

11. The method of updating location-based data available to a network of users according to claim 3, wherein said at least a first object is a police vehicle.

12. A method of providing personalized navigation services including the steps of:
identifying a location of a user;
identifying a destination of a user;
identifying a set of nodes;
identifying a weight for the route between said location of said user and each node in said set of nodes, a weight for the route between each node in said set of nodes and each other node in said set of nodes, and a weight for the route between each node in said set of nodes and said destination of said user;
determining a desired route between said location of said user and said destination of said user by identifying a combination of routes between said location of said user and said destination of said user that results in the most desirable weight; and
instructing said user to proceed along said routes.

13. The method of providing personalized navigation services according to claim 12, wherein the weight for each route is determined by environmental conditions within each route and said user's preference for said environmental conditions.

14. The method of providing personalized navigation services according to claim 13, wherein preferable environmental conditions have a lower weight than non-preferable environmental conditions and said most desirable weight is the lowest possible weight.

15. The method of providing personalized navigation services according to claim 13, wherein preferable environmental conditions have a higher weight than non-preferable environmental conditions and said most desirable weight is the highest possible weight.

16. The method of providing personalized navigation services according to claim 13, wherein said user's preference for said environmental conditions is set manually.

17. The method of providing personalized navigation services according to claim 13, wherein said user's preference for said environmental conditions is set based on said user's previous navigation behavior.
